(19) United States
(12) Patent Application Publication
(10) Pub. No.: US 2016/0052250 A1
(43) Pub. Date: Feb. 25, 2016

(54) FRIT ENCAPSULATION APPARATUS

(71) Applicant: CHUNGHWA PICTURE TUBES, LTD., Taoyuan County (TW)

(72) Inventors: Yi-Wen Chiu, Taoyuan County (TW); Sheng-Fa Liu, Hsinchu County (TW); Ji-Yi Chiou, Taichung City (TW); Ching-Yu Huang, Taipei City (TW); Ming-Hsiang Lai, Changhua County (TW); Yen-Wei Liu, Chiayi County (TW)

(21) Appl. No.: 14/526,624

(22) Filed: Oct. 29, 2014

(30) Foreign Application Priority Data
Aug. 21, 2014 (TW) 103214966

(51) Int. Cl. B32B 37/10; B32B 37/06

(52) U.S. Cl. CPC B32B 37/10; B32B 37/06; B32B 2309/10

(57) ABSTRACT

A frit encapsulation apparatus includes a carriage, a mask, a laser light source and a pressure element. The carriage is disposed over a first substrate. The mask is disposed in the carriage and has a light-transmitting region. The laser light source is disposed in the carriage and over the mask and is configured to provide laser light through the light-transmitting region of the mask and the first substrate therebeneath to heat the frit beneath the first substrate. The pressure element is disposed beneath the carriage and is configured to provide a pressure to the first substrate, such that the first substrate is adhered to a second substrate by the heated frit, in which the pressure element is not overlapped with a vertical projection of the light-transmitting region on the first substrate.

### RELATED APPLICATIONS

This application claims priority to Taiwanese Application Serial Number 103214966, filed Aug. 21, 2014, which is herein incorporated by reference.

### BACKGROUND

1. Field of Invention

The present invention relates to a frit encapsulation apparatus.

2. Description of Related Art

The biggest problem of an organic light-emitting device is that lifetime is too short. It is because water vapor and oxygen in atmosphere easily enter into the organic light-emitting device to react with organic light-emitting elements, which results in deformation, oxidation, resistance increasing, luminance decreasing and driving voltage increasing of the organic light-emitting elements, and even results in short-circuit of elements, and thus the lifetime of the organic light-emitting device is significantly reduced. For example, a metal electrode (e.g., aluminum cathode) of the organic light-emitting elements easily reacts with oxygen to form metal oxide, such that the resistance is increased. Water vapor in the device performs electrolysis oxidation-reduction reaction to form hydrogen, which causes peel between the cathode and an organic layer or uplift of the cathode, and thus to form black spots.

In order to solve the problem of short lifetime of the organic light-emitting device, an encapsulation structure can be formed around the organic light-emitting device to prevent water vapor and oxygen from entering into the organic light-emitting device. Encapsulating materials such as UV curing adhesive and frit have been provided but respectively have advantages and disadvantages. The encapsulation process of the UV curing adhesive is easy, but the UV curing adhesive exhibits poor water and oxygen blocking property, and thus the lifetime of the organic light-emitting device cannot be significantly increased. In addition, a hygroscopic agent should be stuck in the organic light-emitting device due to the poor water and oxygen blocking property of the UV curing adhesive, and thus the organic light-emitting device becomes thicker.

The frit possesses good water blocking property, but the frit between two substrates should be heated using laser to let the two substrates adhere to each other. However, the frit over one of the two substrates may not be able to be in contact with the other substrate during laser heating, which results in incomplete adhesion between the two substrates. In addition, the laser may burn surrounding organic light-emitting elements and thin film transistors. Accordingly, how to solve the problems becomes one of the important issues in this field.

### SUMMARY

The present invention provides a frit encapsulation apparatus could block a portion of laser light to avoid burning of surrounding organic light-emitting elements and thin film transistors, and also provide an appropriate pressure to a substrate to let the frit thereon be tightly in contact with another substrate, and thus the two substrates can be completely adhered to each other.

The frit encapsulation apparatus of the present invention includes a carriage, a mask, a laser light source and a pressure element. The carriage is disposed over a first substrate. The mask is disposed in the carriage and has a light-transmitting region. The laser light source is disposed in the carriage and over the mask. The laser light source is configured to provide laser light through the light-transmitting region of the mask and the first substrate therebeneath to heat the frit beneath the first substrate. The pressure element is disposed beneath the carriage and is configured to provide a pressure to the first substrate, such that the first substrate is adhered to a second substrate by the heated frit, in which the pressure element is not overlapped with a vertical projection of the light-transmitting region on the first substrate.

According to one embodiment of the present invention, the light-transmitting region of the mask has a maximum width greater than a width of the frit.

According to one embodiment of the present invention, the pressure element is a plurality of universal balls.

According to one embodiment of the present invention, the universal balls surround the vertical projection of the light-transmitting region on the first substrate.

According to one embodiment of the present invention, each of the universal balls has a diameter in a range of 10 mm to 20 mm.

According to one embodiment of the present invention, the universal balls are two universal balls.

According to one embodiment of the present invention, the universal balls are three or more universal balls and arranged in a regular polygon, and the vertical projection of the light-transmitting region on the first substrate is overlapped with incenter of the regular polygon.

According to one embodiment of the present invention, the universal balls are four universal balls and arranged in a square.

According to one embodiment of the present invention, the carriage includes a first carrier plate and a second carrier plate, which are substantially parallel to the first substrate, and the second carrier plate is disposed between the first carrier plate and the first substrate, and the laser light source is in contact with the first carrier plate, and the mask is in contact with the second carrier plate, and the universal balls are disposed at a lower surface of the second carrier plate.

According to one embodiment of the present invention, the frit encapsulation apparatus further includes a plurality of pressure regulator elements between the first carrier plate and the second carrier plate, and each of the pressure regulator elements is configured to adjust the pressure to the first substrate toward the second substrate from one of the universal balls.

According to one embodiment of the present invention, each of the pressure regulator elements is connected to the first carrier plate and the second carrier plate.

### BRIEF DESCRIPTION OF THE DRAWINGS

The invention can be more fully understood by reading the following detailed description of the embodiment, with reference made to the accompanying drawings as follows:

FIG. 1 is a cross-sectional view of a frit encapsulation apparatus, a frit, a first substrate and a second substrate according to one embodiment of the present invention;

FIG. 2 is a cross-sectional view of a frit encapsulation apparatus, a frit, a first substrate and a second substrate according to another embodiment of the present invention;

FIG. 3 is a perspective view of a frit encapsulation apparatus according to one embodiment of the present invention; and

FIG. 4 is a top view of universal balls, a vertical projection of a light-transmitting region on a first substrate and a frit according to one embodiment of the present invention.

### DETAILED DESCRIPTION

As related art mentioned, existing frit encapsulation methods have problems of burning of surrounding organic light-emitting elements and thin film transistors and incomplete adhesion between two substrates. Accordingly, the present invention provides a frit encapsulation apparatus could block a portion of laser light to avoid burning of the surrounding organic light-emitting elements and thin film transistors, and also could provide an appropriate pressure to a substrate to let the frit thereon be tightly in contact with another substrate, and thus the two substrates can be completely adhered to each other.

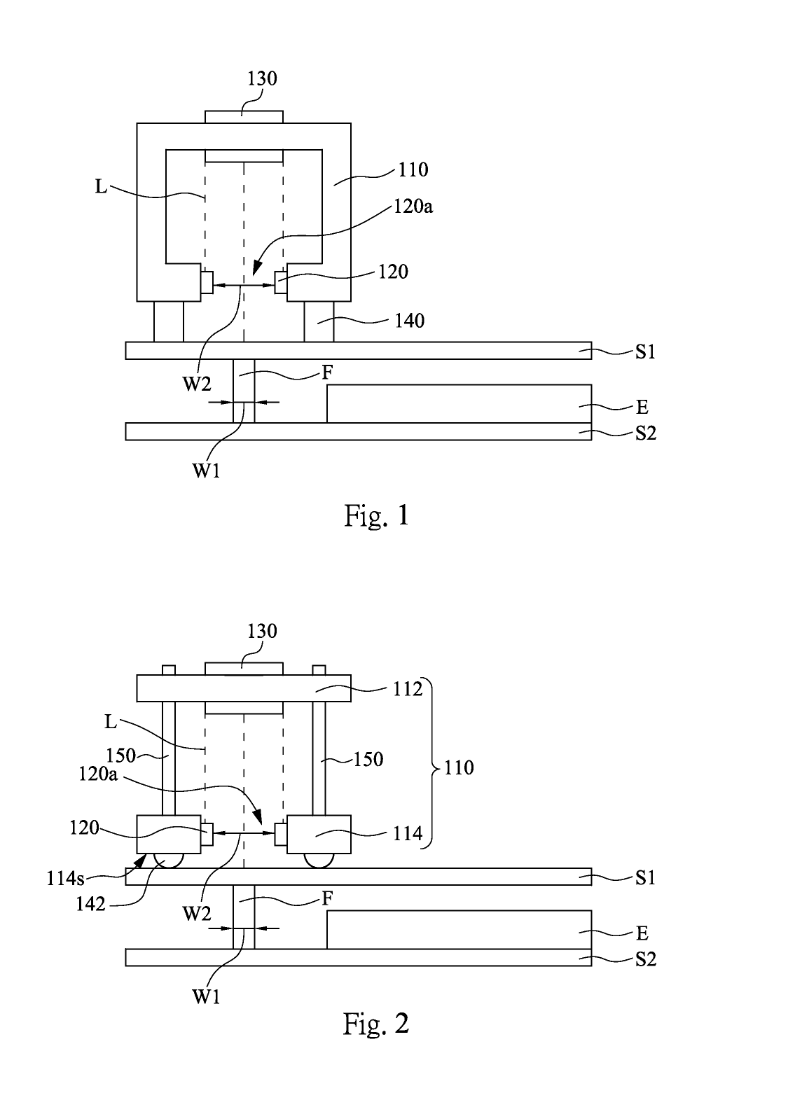

FIG. 1 is a cross-sectional view of a frit encapsulation apparatus, a frit, a first substrate and a second substrate according to one embodiment of the present invention. As shown in FIG. 1, the frit encapsulation apparatus is configured to heat the frit F beneath the first substrate S1 and let the melted frit F be in contact with the second substrate S2, such that the first substrate S1 is adhered to the second substrate S2. In one embodiment, the first substrate S1 is substantially parallel to the second substrate S2. In one embodiment, the second substrate S2 includes an element E, such as an organic light-emitting element, a thin film transistor or other elements. In one embodiment, the first substrate S1 and the second substrate S2 constitute an organic light-emitting device. In one embodiment, the first substrate S1 is a glass cap substrate, and the second substrate S2 is an active organic light-emitting display panel. The active organic light-emitting display panel may be a top emission type organic light-emitting display panel or a bottom emission type organic light-emitting display panel.

The frit encapsulation apparatus includes a carriage 110, a mask 120, a laser light source 130 and a pressure element 140. The carriage 110 is disposed over the first substrate S1. The carriage 110 is an integrally formed structure or constituted by a plurality of carrier plates (not shown). The mask 120 and the laser light source 130 are disposed at specific positions in the carriage 110. When the carriage 110 is moved, the mask 120 and the laser light source 130 are moved along therewith.

The mask 120 is disposed in the carriage 110. The mask 120 is configured to block a portion of laser light L to avoid burning of the element E. The mask 120 has a light-transmitting region 120a configured to let another portion of the laser light L pass through the light-transmitting region 120a and then through the first substrate S1 therebeneath to heat the frit F. In one embodiment, the light-transmitting region 120a is an opening. In another embodiment, the light-transmitting region is a laser light-transmitting material, such as a quartz glass or other suitable materials. In one embodiment, a maximum width W2 of the light-transmitting region 120a of the mask 120 is greater than a width W1 of the frit F, and thus the frit F can be completely heated. However, the maximum width W2 of the light-transmitting region 120a cannot be too large, otherwise the element E will be burned. It is noteworthy that there is only need to let the carriage 110 move along a pattern of the frit F to continuously heat the frit F by the laser light L through the mask 120 during encapsulation using the frit encapsulation apparatus of the present invention, such that there is no need to form a full mask, and thus mask cost can be saved. Further, in one embodiment, the mask 120 is replaceable, such as plug-in type, which can be engaged into the carriage 110 or separated from the carriage 110, such that replacement of the mask 120 is very convenient.

The laser light source 130 is disposed in the carriage 110 and over the mask 120. The laser light source 130 is configured to provide the laser light L through the light-transmitting region 120a and the first substrate S1 therebeneath to heat the frit F beneath the first substrate S1. Suitable wavelength or energy ranges of the laser light source 130 may be selected according to material properties of the frit F.

The pressure element 140 is disposed beneath the carriage 110 and in contact with a portion of the first substrate S1. The pressure element 140 is configured to provide a pressure to the portion of the first substrate S1 toward the second substrate S2, and thus to let the melted frit F be tightly in contact with the second substrate S2, such that the first substrate S1 is adhered to the second substrate S2. In one embodiment, the pressure applied from the pressure element 140 is in a range of 0.1 kg/cm² to 3 kg/cm², but not limited thereto.

It is noted that the pressure element 140 provides the pressure to the portion of the first substrate S1 rather than provides a pressure to the entire first substrate S1, so that injury of the element E will not occur. Further, the pressure element 140 is not overlapped with a vertical projection of the light-transmitting region 120a on the first substrate S1; that is, the pressure element 140 does not directly provide the pressure to the frit F, and thus there are no micro-cracks generated in the frit F. If there are micro-cracks formed in the frit F, the micro-cracks may be expanded to destruct encapsulation property between the first substrate S1 and the second substrate S2.

There may be one or more pressure elements 140. The pressure element 140 may be any shape in top view. In one embodiment, the pressure element 140 is a two-way roller. In one embodiment, two pressure elements 140 surround the vertical projection of the light-transmitting region 120a on the first substrate S1.

FIG. 2 is a cross-sectional view of a frit encapsulation apparatus, a frit, a first substrate and a second substrate according to another embodiment of the present invention. In the embodiment, the carriage 110 includes a first carrier plate 112 and a second carrier plate 114, which are substantially parallel to the first substrate S1. The second carrier plate 114 is disposed between the first carrier plate 112 and the first substrate S1. The laser light source 130 is in contact with the first carrier plate 112, and the mask 120 is in contact with the second carrier plate 114.

In the embodiment, the pressure element is a plurality of universal balls 142, which are disposed at a lower surface 114s of the second carrier plate 114 and in contact with the first substrate S1. The lower surface 114s faces the first substrate S1. The universal balls 142 are able to move over the first substrate S1.

In the embodiment, the frit encapsulation apparatus further includes a plurality of pressure regulator elements 150 between the first carrier plate 112 and the second carrier plate 114. Each of the pressure regulator elements 150 is configured to adjust the pressure to the first substrate S1 toward the second substrate S2 from one of the universal balls 142. In one embodiment, each of the pressure regulator elements 150 is connected to the first carrier plate 112 and the second carrier plate 114. The pressure regulator element 150 may be raised or lowered to adjust the pressure to the first substrate S1 provided from the universal ball 142. For example, the pressure becomes smaller when the pressure regulator element 150 is raised; the pressure becomes larger when the pressure regulator element 150 is lowered. The pressure regulator element 150 may be a screw rod or a screw, or provides pressure to the pressure element 150 using an air cylinder.

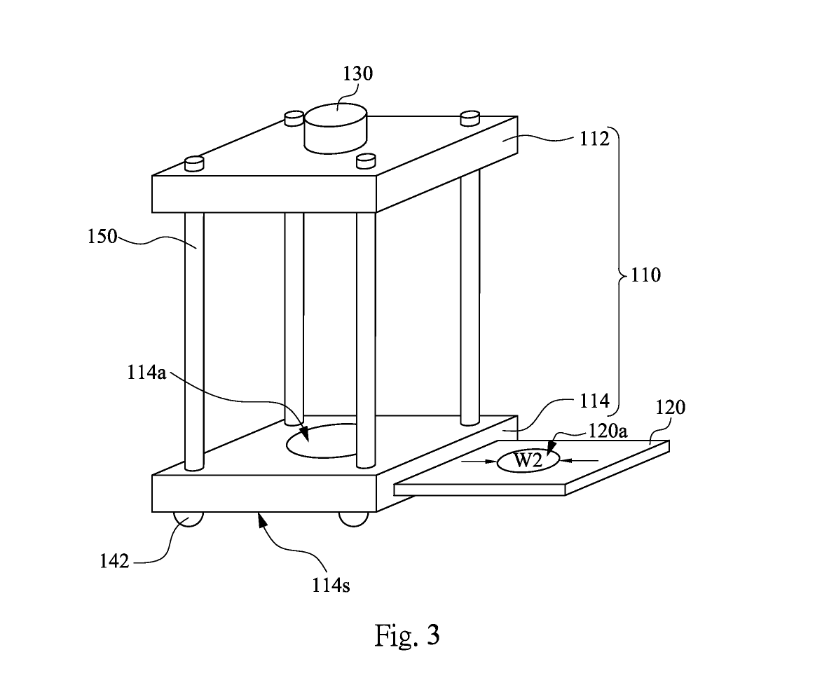

FIG. 3 is a perspective view of a frit encapsulation apparatus according to one embodiment of the present invention. In the embodiment, the mask 120 is the plug-in type, which can be inserted into the second carrier plate 114 in parallel. The second carrier plate 114 has an opening 114a. After the mask 120 is inserted into the second carrier plate 114, the light-transmitting region 120a of the mask 120 may be substantially aligned with the opening 114a. In one embodiment, the light-transmitting region 120a is circular in top view, but it may also be elliptical, polygonal, ring-shaped or other suitable shapes. In the embodiment, there are four universal balls 142 respectively disposed at four corners of the lower surface 114s of the second carrier plate 114. In the embodiment, there are four pressure regulator elements 150 to respectively control the pressures of the four universal balls 142.

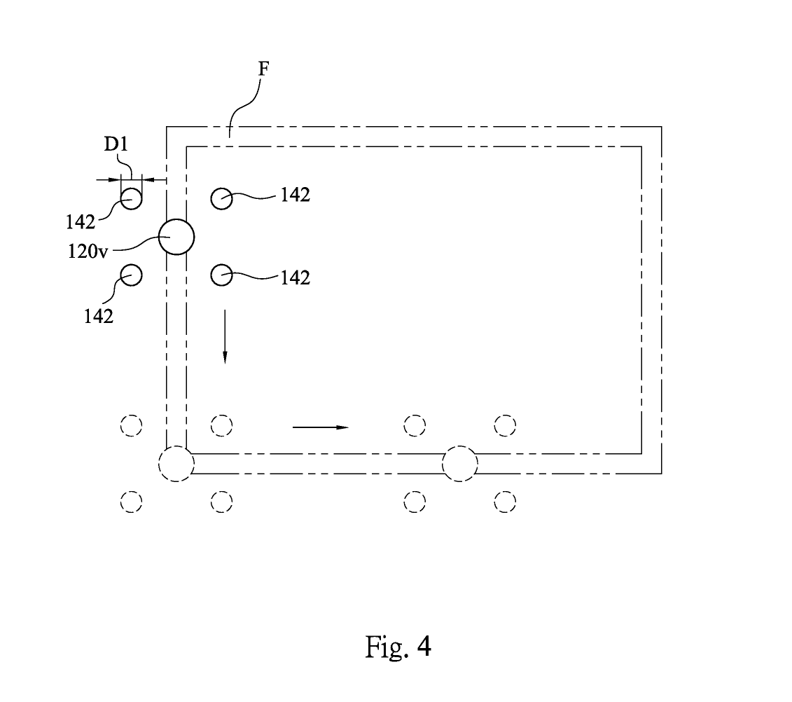

FIG. 4 is a top view of universal balls, a vertical projection of a light-transmitting region on a first substrate and a frit according to one embodiment of the present invention. In the embodiment, the universal balls 142 surround the vertical projection 120v of the light-transmitting region on the first substrate. In the embodiment, there are four universal balls 142 arranged in a square. The vertical projection 120v of the light-transmitting region on the first substrate is overlapped with an intersection of two diagonals of the square. The four universal balls 142 may also be arranged in a rectangle.

In other embodiment, there are two, three, five or more universal balls. The three or more universal balls may be arranged in a regular polygon, such as regular triangle, regular pentagon, regular hexagon, etc, and the vertical projection of the light-transmitting region on the first substrate is overlapped with incenter (i.e., center of inscribed circle) of the regular polygon to provide uniform pressure to the first substrate.

It is noteworthy that as shown in FIG. 4, there is no universal ball 142 directly providing pressure to the frit F to avoid generation of micro-cracks. In one embodiment, each of the universal balls 142 has a diameter D1 in a range of 10 mm to 20 mm. A distance between the universal ball 142 and the vertical projection 120v of the light-transmitting region on the first substrate may be adjusted to provide an appropriate pressure without injuring the element.

In addition, the frit encapsulation process is described below in detail. Referring to FIGS. 2-4, the laser light source 130 and the mask 120 of the carriage 110 may be moved along a direction of arrows of FIG. 4 to let the laser light L continuously heat the frit F. At the same time, the four universal balls 142 provide uniform pressure, and thus the melted frit F may be in contact with the second substrate S2 to let the first substrate S1 tightly adhere to the second substrate S2. The pressure provided from the universal ball 142 may be reduced using the pressure regulator element 150 when the carriage 110 turns and the universal ball 142 passes over the frit F, so as to avoid generation of micro-cracks in the cured frit F.

Given above, the frit encapsulation apparatus of the present invention is able to block the portion of the laser light to avoid burning of the surrounding organic light-emitting elements and the thin film transistors, and also able to provide the appropriate pressure to the substrate to let the frit thereon be tightly in contact with the other substrate, and thus the two substrates can be completely adhered to each other. The frit encapsulation apparatus also has advantages described below. There is no need to form the full mask since the mask and the laser light source are integrated in the carriage. The pressure element provides the pressure to the portion of the substrate rather than to the entire substrate, and thus the element will not be damaged. In addition, the pressure element does not directly provide the pressure to the frit, and thus no micro-cracks will be generated in the frit.

It will be apparent to those ordinarily skilled in the art that various modifications and variations may be made to the structure of the present invention without departing from the scope or spirit of the invention. In view of the foregoing, it is intended that the present invention cover modifications and variations thereof provided they fall within the scope of the following claims.

What is claimed is:

1. A frit encapsulation apparatus, comprising:
a carriage disposed over a first substrate;
a mask disposed in the carriage and having a light-transmitting region;
a laser light source disposed in the carriage and over the mask and configured to provide laser light through the light-transmitting region of the mask and the first substrate therebeneath to heat the frit beneath the first substrate; and
a pressure element disposed beneath the carriage and configured to provide a pressure to the first substrate, such that the first substrate is adhered to a second substrate by the heated frit, wherein the pressure element is not overlapped with a vertical projection of the light-transmitting region on the first substrate.

2. The frit encapsulation apparatus of claim 1, wherein the light-transmitting region of the mask has a maximum width greater than a width of the frit.

3. The frit encapsulation apparatus of claim 1, wherein the pressure element is a plurality of universal balls.

4. The frit encapsulation apparatus of claim 3, wherein the universal balls surround the vertical projection of the light-transmitting region on the first substrate.

5. The frit encapsulation apparatus of claim 3, wherein each of the universal balls has a diameter in a range of 10 mm to 20 mm.

6. The frit encapsulation apparatus of claim 3, wherein the universal balls are two universal balls.

7. The frit encapsulation apparatus of claim 3, wherein the universal balls are three or more universal balls and arranged in a regular polygon, and the vertical projection of the light-transmitting region on the first substrate is overlapped with incenter of the regular polygon.

8. The frit encapsulation apparatus of claim 7, wherein the universal balls are four universal balls and arranged in a square.

9. The frit encapsulation apparatus of claim 3, wherein the carriage comprises a first carrier plate and a second carrier plate, which are substantially parallel to the first substrate, and the second carrier plate is disposed between the first carrier plate and the first substrate, and the laser light source is in contact with the first carrier plate, and the mask is in contact with the second carrier plate, and the universal balls are disposed at a lower surface of the second carrier plate.

10. The frit encapsulation apparatus of claim 9, further comprising a plurality of pressure regulator elements between the first carrier plate and the second carrier plate, and each of the pressure regulator elements is configured to adjust the pressure provided to the first substrate toward the second substrate from one of the universal balls.

11. The frit encapsulation apparatus of claim 10, wherein each of the pressure regulator elements is connected to the first carrier plate and the second carrier plate.
